(19) United States
(12) Patent Application Publication
(10) Pub. No.: US 2011/0044078 A1
(43) Pub. Date: Feb. 24, 2011

(54) METHOD FOR CONVERTING DIRECT CURRENT TO ALTERNATING CURRENT

(75) Inventor: Herbert Pardo, Conyers, GA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: DIFFERENTIAL POWER LLC, Conyers, GA (US)

(21) Appl. No.: 12/601,092

(22) PCT Filed: May 21, 2008
(86) PCT No.: PCT/US08/64340

§ 371 Date: Oct. 8, 2010

Related U.S. Application Data
(60) Provisional application No. 60/930,978, filed on May 21, 2007.

(51) Int. Cl. H02M 7/02

(52) U.S. Cl. 363/102

(57) ABSTRACT

A direct current to alternating current inverter is described herein. In an embodiment of the present subject matter, various direct voltage electrical potentials are applied to rings of a rotor so that each ring of the rotor is a different direct current potential. Preferably, the direct current potentials are applied in a manner so that the potential increases or decreases from a center ring to an outer ring, or vice versa. A stator has brush assembly having a series of brushes. Each brush is physically connected to a ring in such a way that the brush picks up the voltage. As a motor spins the rotor, the voltages picked up by the static brush assembly increase in positive potential, then decrease in positive potential, then increase in negative potential, and then finally decrease in negative potential, generating an alternating current.

### CROSS REFERENCE TO RELATED APPLICATIONS

This application claims benefit of U.S. Provisional Application No. 60/930,978, filed May 21, 2007, entitled “Power Signal Generator Method of Generating Electrical Waves of a Differential Voltage Device,” the entire contents of which are hereby incorporated herein by reference.

### FIELD OF THE INVENTION

The disclosed subject matter is related to the conversion of direct current to alternative current.

### BACKGROUND

Auxiliary power systems based on direct current power supplies, such as batteries, provide several uses, including backup electrical current when normal power is interrupted or unavailable. Most public electrical utilities provide alternating current due to limitations of direct current. Thus, inverters are used to convert direct current to alternating current.

### SUMMARY

A direct current to alternating current inverter is described herein. In an embodiment of the present subject matter, various direct voltage electrical potentials are applied to rings of a rotor so that each ring of the rotor is a different direct current potential. Preferably, the direct current potentials are applied in a manner so that the potential increases or decreases from a center ring to an outer ring, or vice versa. A stator has brush assembly having a series of brushes. Each brush is physically connected to a ring in such a way that the brush picks up the voltage. As a motor spins the rotor, the voltages picked up by the static brush assembly increase in positive potential, then decrease in positive potential, then increase in negative potential, and then finally decrease in negative potential, generating an alternating current.

### BRIEF DESCRIPTION OF THE DRAWINGS

The foregoing and other aspects of the present subject matter will be better understood from the following detailed description with reference to the drawings.

FIG. 1 is a backside illustration of an exemplary and non-limiting rotor assembly;

FIG. 2 is a front-side illustration of an exemplary and non-limiting rotor assembly;

FIG. 3 is a front-side illustration of an exemplary and non-limiting stator;

FIG. 4 is an illustration of a side view of an exemplary and non-limiting stator;

FIG. 5 is an illustration of an exemplary and non-limiting inverter assembly;

FIG. 6 is an example output voltage of the inverter of FIG. 5;

FIG. 7 is an illustration of an exemplary and non-limiting inverter assembly for generating three phase alternating current;

FIG. 8 is an example output voltage of the inverter of FIG. 7; and

FIG. 9 is a front-side illustration of an exemplary and non-limiting stator configured to increase amperage output of an inverter.

### DETAILED DESCRIPTION OF ILLUSTRATIVE EMBODIMENTS

The subject matter of the various embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

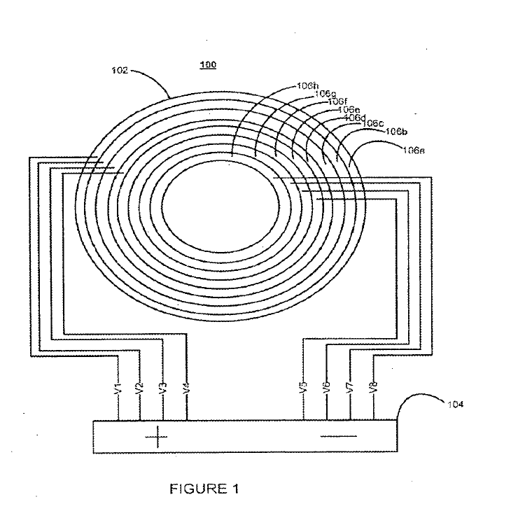

In the present subject matter, a differential direct current power supply is electrically connected to a rotor in a manner that imparts various direct current potentials onto a plurality of rings of the rotor. An embodiment of the present subject matter is described as using a battery as the direct current power supply, though other direct current power supplies may be used, including without limitation, a direct current generator, a solar panel, and a wind mill generator. A stator having a brush assembly is electrically connected to the rotor. When the rotor rotates, the brush assembly on the stator picks up the various potentials, outputting an alternating current. FIG. 1 is a backside illustration of an exemplary and non-limiting rotor assembly for use in an inverter of the present subject matter.

In FIG. 1, rotor assembly 100 has rotor 102 which is electrically connected to differential voltage power supply 103. Power supply 103 may be one or more direct current power sources configured to have a plurality of input potentials ranging from an upper positive potential to a lesser positive potential. The lesser positive potential may be a ground or negative potential. The plurality of input potentials are shown in FIG. 1 as input potentials V1-V8. In one exemplary and non-limiting embodiment, input potential V1 may be the highest positive potential, with input potentials V2-V4 being lower positive potentials in descending order from input potential V2 to input potential V4, with input potential V4 being the lowest positive potential. Input potential V8 may be the highest negative potential, with input potentials V7-V5 being lower negative potentials in descending order from input potential V7 to input potential V5, with input potential V5 being the lowest negative potential. Preferably, input potentials V1-V8 are direct current potentials and remain relatively constant for a certain configuration.

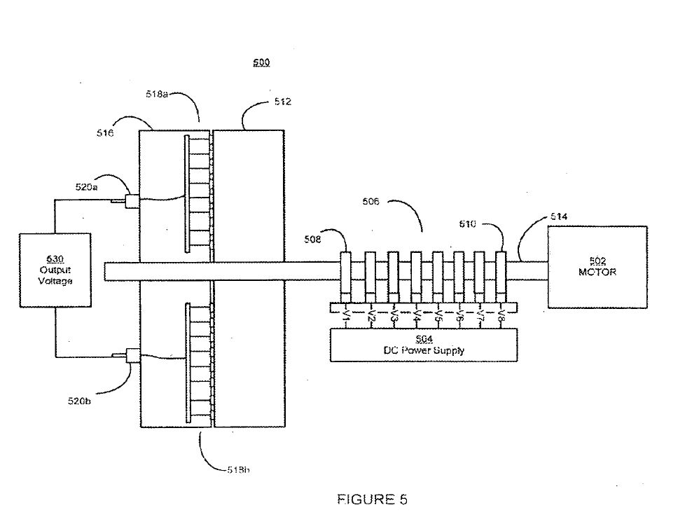

Input potentials V1-V8 are electrically connected to rings 106a-h of rotor 102. Shown by example in FIG. 1, input potential V1 is electrically connected to ring 106a of rotor 102, input potential V2 is electrically connected to ring 106b of rotor 102, and so forth, with input potential V8 being electrically connected to ring 106h of rotor 102. There may be various ways in which to connect rings 106a-h to power supply 103, an example of which is illustrated with respect to FIG. 5, below.

Input potentials V1-V8 are electrically connected to rings 106a-h, rings 106a-h, imparting various potentials on rings 106a-h. For example, in the embodiment shown in FIG. 1, ring 106a has the highest positive potential because ring 106a is electrically connected to input potential V1. In another example, in the embodiment shown in FIG. 1, ring 106h has the highest negative potential because ring 106h is electrically connected to input potential V8.

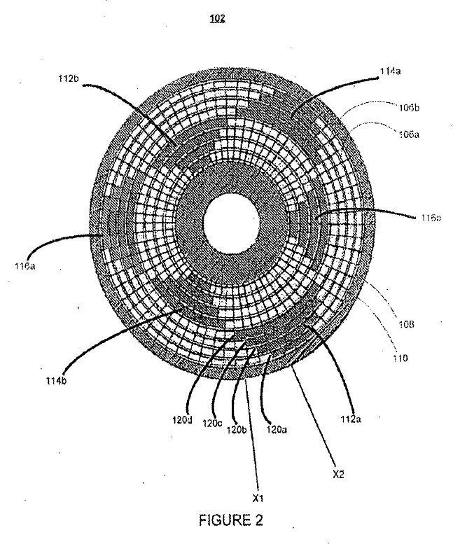

FIG. 2 is a front-side illustration of rotor 102 of FIG. 1. Rotor 102 has a plurality of rings of various potentials. Shown for example are rings 106a and 106b, which correspond to rings 106a and 106b of FIG. 1. Rings 106c-h are not indicated, though it should be understood that the rings are present in rotor 102. The rings of rotor 102 may be configured so that certain portions of the rings of rotor 102, such as ring 106a, have exposed surfaces that present the applied input potential to an external object upon contact while other portions may be electrically insulated so that their exposed surfaces do not present the input potential upon contact by an external object.

This may be accomplished by segmenting the rings of rotor 102 into segments, shown by example as segments 110 and 108, and insulating them. The insulating means may be done by various means, such as by disconnecting segments 108 and 110 from the applied input potential or by applying an insulating material to the surface of segments 108 and 110. Additionally, the various segments on a ring may be electrically grouped together. For example, a collection of segments shown collectively as subrings 120a of output section 112a may be electrically connected with each other and configured to have a surface that exposes the applied input potential to ring 106a.

In the present embodiment, the various rings, such as ring 106a and ring 106b, of rotor 102 are configured to be electrically isolated from each other. This is done to establish output sections, such as output section 112a, that are configured to impart electrical potentials on to brushes of a stator (not shown). The output sections are comprised of subrings which are grouped segments of various rings of the stator. As shown by example in FIG. 2, output section 112a has subrings 120a-d. Subrings 120a are grouped segments, shown as black segments, of the rings of rotor 102. For example, subring 120a is a grouped segment of ring 106a and subring 120b is a grouped segment of ring 106a.

Subrings 120a-d are segments of their respective rings, and are thus, electrically connected to the various input potentials. Thus, each subring has an exposed surface that is one of the input potential. For example, subring 120a is a grouped segment of ring 106a. Ring 106a is in electrical communication with input potential V1 of FIG. 1. Thus, the exposed surface of subring 120a exposes input potential V1. Thus, in the present example, subring 120b exposes input potential V2, subring 120c exposes input potential V3, and subring 120d exposes potential V4. In the present example, output section 112a collectively exposes positive potentials of varying magnitude. Output section 114a and output section 116a are configured in a similar manner to output section 112a. Output sections 112b, 114b and 116b are connected in a manner similar to output sections 112a, 114a, and 116a, but are connected to negative input potentials. Thus, rotor 102 has multiple segments that expose various direct current input potentials of varying magnitudes and polarity.

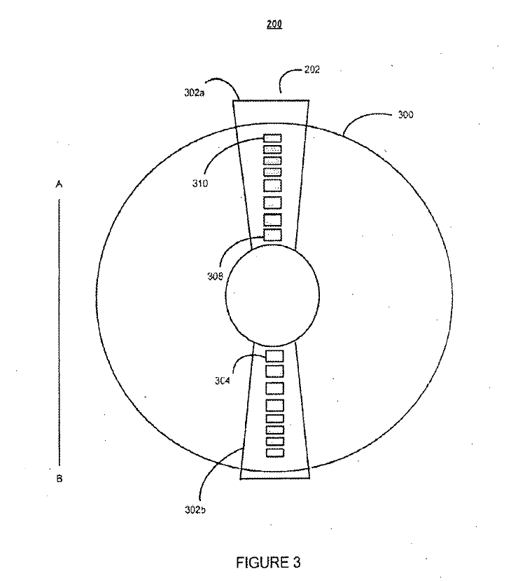

To pick up or receive the potentials of varying magnitudes and polarity to generate an alternating current output, the present subject matter uses a stator assembly having a stator with brushes. Shown in FIG. 3 is stator assembly 200 having stator 300 and brush assembly 202 affixed to stator 300. Stator 300 is disposed proximate to a rotor of the present subject matter, such as rotor 102 of FIG. 1. As rotor 102 of FIG. 1 rotates, brushes in brush assembly 202, which are in electrical contact with the front-side of rotor 102, receive the exposed potential of the sections of the rotor 100, such as output sections 112a and 112b of rotor 102.

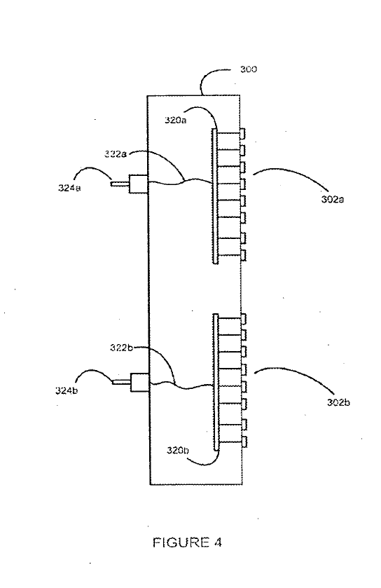

In the present embodiment, brush assembly 202 has first portion 302a and second portion 302b. First portion 302a and second portion 302b are configured to transfer the potential received to an output, the manner of which will be described below. Each brush of brush assembly 202 is preferably in physical contact with a ring of a rotor to receive the input potential. For example, brush 310 may be in physical contact with ring 106a of FIG. 1. In another example, brush 304 and brush 308 may be configured to be in contact with ring 106h of FIG. 1. As will be shown more fully in reference to FIG. 4, below, the brushes of first portion 302a are connected in parallel and are separate from the brushes of second portion 302b, which are also connected in parallel.

Thus, the potential output of first portion 302a or second portion 302b will be the maximum potential received at any of the brushes. In other words, in the present example, if the rotor of FIG. 2 is in a position such that brush 310 of brush assembly 202 is in contact with subring 120a, the output voltage of first portion 302a will be the maximum input potential, or V1 in the present example. For example, when rotor 102 of FIG. 2 rotates to a position such that axis X1 aligns with axis AB of stator 300 of FIG. 3, which in the present example is a reference axis running through the center of brush assembly 202 from first portion 302a to second portion 302b, brush 308 is the only brush of first portion 302a that is in communication with a subring that is exposing an electrical potential, in this example, subring 120d. In this alignment, the output voltage of stator 300 would be the potential on subring 120d, or V4, the minimum positive voltage.

Continuing with the present example, if rotor 102 of FIG. 2 rotates to so that axis X1 aligns with axis AB of FIG. 3, the output voltage will be the maximum positive voltage because brush 310 of first portion 302a is in electrical contact with subring 120a, which is the maximum input voltage, or V1. It can also be seen that when axis X1 aligns with axis AB, brush 304 of second portion 302b is in contact with the subring exposing the maximum negative potential. Thus, as the rotor, such as rotor 102 of FIG. 2, rotates, the output voltage of first portion 302a and second portion 302b changes.

When looking at FIG. 3 in combination with FIG. 2, if a starting reference point of rotation is axis X2 of rotor 102 being aligned with axis AB of stator 300, the output voltage of first portion 302a is at the maximum potential, or V1. As rotor 102 rotates so that axis X2 is aligned with axis AB, the output voltage of first portion 302a is at the minimum positive voltage, or V4. If rotor 102 were to continue to rotate to output section 114b of rotor 102 of FIG. 2, the output voltages would first increase negative then decrease negative as the rotation continues.

Further, in the present example, when rotor 102 of FIG. 2 is positioned so that axis X2 is aligned with axis AB, second portion 302b is in communication with output section 112b. In that alignment, first portion 302a would be outputting the maximum positive voltage and second portion 302b would be outputting the maximum negative voltage. As can be seen, as rotor 102 of FIG. 2 rotates, the output voltages of first section 302a and second section 302b change depending upon the position of brush assembly 202 on rotor 102.

As discussed above, the brushes of brush assembly 202 of FIG. 2 are electrically connected in a manner to provide an output potential. FIG. 4 is an illustration of an exemplary and non-limiting way in which the brushes of a brush assembly, such as brush assembly 202, may be connected. Shown is a side view of stator 300, illustrating the placement of first portion 302a and second portion 302b on stator 300. The brushes of first portion 302a are electrically connected in parallel, illustrated by electrical bridge 320a. Bridge 320a has output connection 322a, which electrically transfers the potential at bridge 320a to output terminal 324a. In a similar manner, brushes of second portion 302b are connected in parallel using bridge 320b. Bridge 320b is electrically connected to output terminal 324b via output connection 322b.

FIG. 5 is an illustration of exemplary inverter 500. DC power supply 504 is preferably a differential direct current power supply that provides potentials of various magnitudes and polarities. In the present example, potentials V1-V8, as described in FIG. 1, are applied to the slip rings of slip ring assembly 506. The slip rings, such as slip ring 508 and slip ring 510, are electrically connected to rings of rotor 512. For example, slip ring 508 may be connected to ring 106a if rotor 512 was configured in a similar manner to rotor 102 of FIG. 1. In another example, slip ring 510 may be electrically connected to ring 106h if rotor 512 was configured in a similar manner to rotor 102 of FIG. 1. Thus, in the present example, slip ring assembly 506 provides a way in which the potentials of power supply 504 may be applied to the ring of rotor 512.

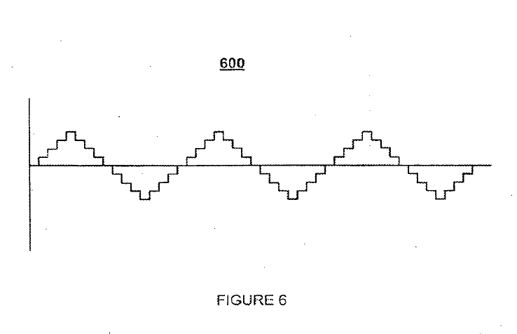

To rotate rotor 512, in the present example, motor 502 is provided. Motor 502 rotates shaft 514 which is connected to rotor 512. It should be noted that the use of motor 502 to spin shaft 514 is by example only, as other ways to rotate shaft 514 and/or rotor 512 may be used. As rotor 512 is spun, brush assemblies 518a and 518b, which in the present example are positioned so that the brushes of brush assemblies 518a and 518b are in physical contact with rotor 512, pick off the potentials exposed by rotor 512 and output those potentials to output terminals 520a and 520b in a manner similar to that described in FIGS. 3 and 4, above. The outputs of output terminals 520a and 520b are connected to produce output voltage 530. The waveform of output voltage 530 is shown by example in waveform 600 of FIG. 6. As rotor 512 is rotated, waveform 600 shows that the output voltage is sinusoidal.

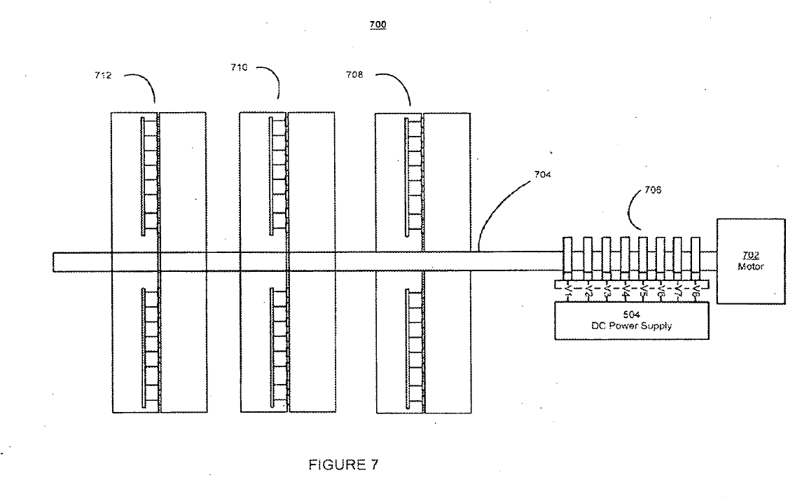

If a multi-phase output or increased power is desired, more than one rotor/stator assembly may be used. For example, FIG. 7 illustrates exemplary multiphase inverter 700. Potentials from power supply 504 are connected to rotor/stator assemblies 708-712 via slip ring assembly 706. Motor 702 rotates shaft 704 which is physically connected to the rotors of rotor/stator assemblies 708-712, which causes all three rotors to rotate. If rotor/stator assemblies 708-712 are configured so that each stator of rotor/stator assemblies 708-712 is outputting the same voltage, the output is three outputs rather than the one shown in FIG. 6.

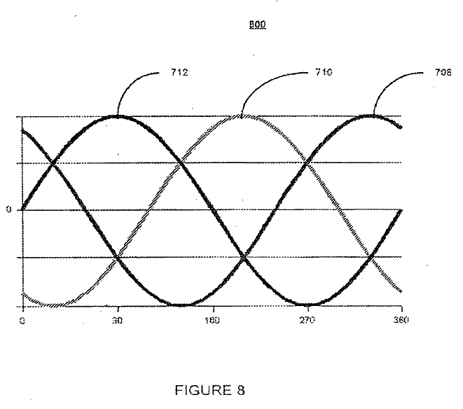

If a multiphase output is desired, rotor/stator assemblies 708-712 may be configured to produce voltages whose peaks are out of phase with each other. In other words, if output voltage from rotor/stator assembly 708 is at a maximum at a “0” phase angle, output voltages from rotor/stator assemblies 710 and 712 may be maximum at other phase angles. This may be shown by waveform 800 in FIG. 8. Output voltage waveform of rotor/stator assembly 708, shown as sinusoidal voltage output 808, is out of phase with the output voltage waveforms of rotor/stator assemblies 710 and 712, shown as sinusoidal voltage outputs 810 and 812, respectively. Thus, by changing the configuration of rotor/stator assemblies 708-712, and by changing the number of rotor/stator assemblies, the output may be increased and/or a multi-phase output may be generated.

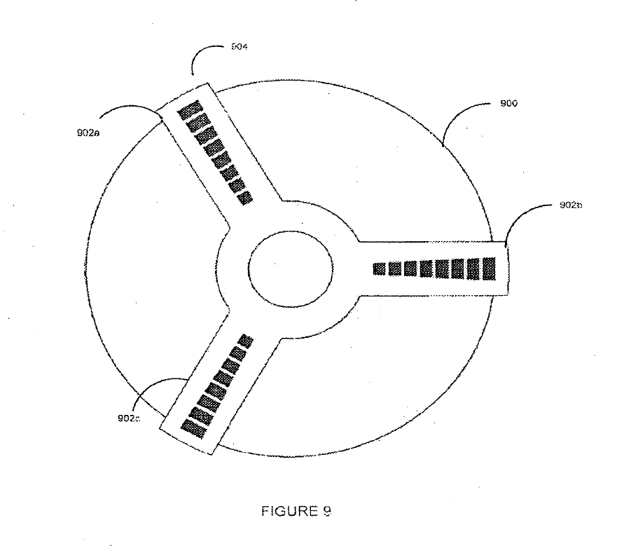

Instead of using additional rotor/stator assemblies to either generate multiple phases or to increase the power output, the stator may be configured differently than described above. FIG. 9 is an illustration of exemplary stator 900 configured to produce three output voltages. Stator 900 has three brush assembly portions, first portion 902a, second portion 902b, and third portion 902c. Each portion outputs the potential received from a rotor (not shown), thus providing three outputs instead of 1, as would be produced by stator 300 of FIG. 3. It should be understood that portions 902a-902c may also have a lower portion, i.e. stator 900 may be configured to have three brush assemblies, such as brush assembly 202 of FIG. 3.

While the present subject matter has been described in connection with the various embodiments of the various figures, it is to be understood that other similar embodiments can be used or modifications and additions can be made to the described embodiment for performing the same function of providing the disclosed subject matter without deviating therefrom. Therefore, the present subject matter should not be limited to any single embodiment, but rather should be construed in breadth and scope in accordance with the appended claims.

What is claimed:

1. A system for converting direct current to alternating current, comprising:
a differential voltage direct current power supply configured to output a plurality of direct current voltage potentials;
a first rotor comprised of a plurality of rings in electrical communication with the plurality of direct current voltage potentials, wherein the plurality of rings are divided into a plurality of subrings configured to expose the plurality of direct current voltage potentials; and
a first stator wherein the first stator is comprised of a first brush portion having a plurality of brushes, wherein the first stator is disposed so that the plurality of brushes are placed in contact with the plurality of rings, wherein the first stator is configured to output a first substantially sinusoidal shaped output voltage when the first rotor is rotated.

2. The system of claim 1, further comprising a slip ring assembly having at least one slip ring in electrical communication with the at least one of the plurality of direct current voltage potentials, wherein the slip ring assembly is also in electrical communication with the at least one slip ring.

3. The system of claim 1, further comprising a rotating means for rotating the first rotor.

4. The system of claim 3, wherein the means for rotating the first rotor comprises a motor configured to provide a rotational force, wherein the means for rotating the first rotor further comprises a shaft connecting the motor to the first rotor.

5. The system of claim 1, wherein the first substantially sinusoidal shaped output voltage is a single phase output voltage.

6. The system of claim 1, wherein the first substantially sinusoidal shaped output voltage is a three phase output voltage.

7. The system of claim 1, further comprising a second stator and a second rotor, wherein the second stator and the second rotor are configured substantially similar to the first rotor and the first stator, wherein the second stator is configured to output a second substantially sinusoidal shaped output voltage.

8. The system of claim 7, further comprising a third stator and a third rotor, wherein the third stator is configured substantially similar to the first stator and the second stator, and wherein the third rotor is configured substantially similar to the first rotor and second rotor, wherein the third stator is configured to output a third second substantially sinusoidal shaped output voltage.

9. The system of claim 8, wherein the first stator, the second stator, and the third stator are configured to generate a three phase output voltage comprised of the first, second and third substantially sinusoidal shaped output voltages.

10. The system of claim 1, further comprising a second brush portion having a second plurality of brushes configured to output a second substantially sinusoidal shaped output voltage.

11. The system of claim 10, further comprising a third brush portion having a third plurality of brushes configured to output a third substantially sinusoidal shaped output voltage.

12. The system of claim 11, wherein the first brush portion, second brush portion and third brush portion are configured to generate a three phase output voltage comprised of the first, second and third substantially sinusoidal shaped output voltages.

13. A method for generating alternating current from a direct current power supply, comprising:
providing a differential voltage direct current power supply configured to output a plurality of direct current voltage potentials;
providing a first rotor comprised of a plurality of rings in electrical communication with the plurality of direct current voltage potentials, wherein the plurality of rings are divided into a plurality of subrings configured to expose the plurality of direct current voltage potentials;
providing a first stator wherein the first stator is comprised of a first brush portion having a plurality of brushes, wherein the first stator is disposed so that the plurality of brushes are placed in contact with the plurality of rings, wherein the first stator is configured to output a first substantially sinusoidal shaped output voltage when the first rotor is rotated; and
rotating the first rotor to generate the first substantially sinusoidal shaped output voltage from the first stator.

14. The method of claim 13, further comprising rotating a second rotor to output a second substantially sinusoidal shaped output voltage and rotating a third rotor to output a third substantially sinusoidal shaped output voltage.

15. The method of claim 14, wherein the first, second and third substantially sinusoidal shaped output voltages are in phase.

16. The method of claim 15, wherein the first, second and third substantially sinusoidal shaped output voltages are out of phase to generate a three phase output comprised of the first, second and third substantially sinusoidal shaped output voltages.

17. An inverter, comprising:
an input configured to receive a plurality of direct current voltage potentials;
a rotor having a plurality of rings in electrical communication with the plurality of direct current voltage potentials, wherein the plurality of rings are divided into a plurality of subrings configured to expose the plurality of direct current voltage potentials;
a stator having a first brush portion having a plurality of brushes, wherein the stator is disposed so that the plurality of brushes are placed in contact with the plurality of rings, wherein the stator is configured to output a substantially sinusoidal shaped output voltage when the rotor is rotated; and
a motor configured to rotate the rotor.

18. The inverter of claim 17, further comprising an output for outputting the substantially sinusoidal shaped output voltage.

19. The inverter of claim 17, wherein the direct current voltage potentials are provided by a battery, a solar panel, a windmill generator, or a direct current generator.
